(19) United States
(12) Patent Application Publication
(10) Pub. No.: US 2019/0331939 A1
(43) Pub. Date: Oct. 31, 2019

(54) Method and Apparatus for Centering of Ophthalmic Lenses

(71) Applicant: Opulens S.A., Buenos Aires (AR)

(72) Inventor: Gabriel Martin, Buenos Aires (AR)

(21) Appl. No.: 16/290,902

(22) Filed: Mar. 2, 2019

(30) Foreign Application Priority Data
Mar. 2, 2018 (AR) P20180100487

(51) Int. Cl. G02C 13/00

(52) U.S. Cl. CPC G02C 13/005

(57) ABSTRACT

A centering arrangement of ophthalmic lenses and centering and alignment method between a centering device and a photographic device so as to allow the correct alignment between the same and to obtain a more optimum lens for the patient.

### CROSS REFERENCE TO RELATED APPLICATION

This application claims benefit under 35 U.S.C. 119 to Patent Application P20180100487 entitled, “OPHTHALMIC LENS CENTERING ARRANGEMENT AND CENTERING METHOD,” filed in Argentina in the Argentina Patent Office (National Institute of Industrial Property) on Mar. 2, 2018, which is incorporated by reference herein in its entirety for all purposes.

### STATE OF THE ART OF THE INVENTION

### Field of Invention

This invention is related to the field of devices, apparatuses and arrangements used in ophthalmology, preferably in the taking of measurements for the realization of ophthalmic lenses and, more particularly, it is related to an arrangement that allows to achieve a correct alignment and centering to carry out the taking of measurements for the later preparation of the ophthalmic lens in a much more practical, fast and easy way, thanks to the utilization of a set of alignment elements arranged in at least one photographic device and one opthalmic lens centering device.

### Background of the Invention

It is well known in the field of art and by those experts in the matter that, the success in the adaptation of ophthalmic lenses in general, and progressive in particular, is strongly associated to a correct calibration of the devices used to carry out the respective measurements that will allow the creation of the ophthalmic lens. That is, the way in which the crystal is positioned in front of the pupil during daily use will determine if the lens is well positioned so as to not harm the patient's vision. All progressive lenses have a point called “PRL” which must coincide with the pupil center when the patient looks towards infinity. This is, in the absence of convergence.

In regards to the naso-pupillary distance for each eye, this can be measured in different ways. One of them, which is the most widely used nowadays, is to block the vision of the eye that will not be measured and place a dot with a permanent marker on the template of the frame centered on the pupil when the patient looks over the professional's shoulder. However, This method is not very precise since the professional must be attentive of the frame and the pupil of the eye of the patient to mark the exact point, so in practice the correct positioning of the lens is not always achieved correctly. Another method is through a centering device that measures the distance between the nose and the pupil, right or left, however, this device does not provide precise information, for example, about the vertical position of the pupil in relation to the frame.

Lastly, there are devices whose functioning principle is based on taking a digital photograph of the patient with the frame in use and measure the distances vertically and horizontally in relation to the pupils and the frame. Nevertheless, a critical point to obtain good accuracy and repetitiveness is to control the alignment and centering of the video camera or lens of the same with the reference device mounted on the frame. A small variation in the angle of capture can mean an incorrect measurement of the distances in question, and in consequence, a bad location of the lens can harm the person's vision.

In view of the current state of the technique available for the measuring devices or arrangements for ophthalmic lenses, it would be very convenient to have a new arrangement that is constituted and constructed in a structurally simple manner so as to notably facilitate the alignment and centering of the pupillary device to create a more adequate and optimum lens for the patient.

### BRIEF SUMMARY OF THE INVENTION

The objective of this new invention is to provide a new arrangement to carry out the correct alignment between a centering device and a photographic device in a much more practical, rapid and easy way.

Another objective of this invention is to provide an alignment arrangement for measurement taking in the creation of a much more optimal ophthalmic lens.

It is also another objective of this invention to provide an alignment arrangement for measurement taking in ophthalmic lenses, of the type used with a centering device and a photographic device, that comprises at least one reflection element arranged in a portion of the centering device; and at least one alignment indicating mark arranged close to a lens provided in that photographic device.

It is still another objective of this invention to provide a centering and alignment method between a centering device and a photographic device in accordance with the alignment arrangement which comprises the following steps: a) place the centering device in a frame of a patient's eyeglasses; b) turn the photographic device on; c) position the lens of the photographic device in alignment with the reflection element of the centering device; d) re-position the lens of the photographic device in such a way that the mark placed closely is reflected in the reflection element, reaching the totality of the mirror section and remaining on the same plane as the mirror; e) take at least one photograph; and f) take the corresponding measurements.

### BRIEF DESCRIPTION OF THE DRAWINGS

For further clarity and comprehension of the objective of this invention, it has been illustrated in various figures in which the invention has been represented in a preferred manner of execution, all of them as examples, where:

FIG. 1 shows a frontal view of the alignment arrangement according to this invention, where a centering arrangement placed on a patient can be observed;

FIG. 2 shows an exemplifying schematic view of one of the parts of the arrangement of the invention provided in a photographic device;

FIG. 3 shows a perspective view of the arrangement of this invention in a mode of use where a non-aligned position can be observed between the centering device and the photographic device; and

FIG. 4 shows a perspective view of the arrangement of this invention in a mode of use where an aligned position can be observed between the centering device and the photographic device.

### DETAILED DESCRIPTION OF THE INVENTION

In reference to the figures we can see the invention consists of a new alignment arrangement for measurement taking in ophthalmic lenses, and an alignment method to align at least one centering device and one photographic device, in a much more practical, rapid and easy manner. We highlight that, a photographic device must be understood as a device capable of capturing an image, for example: photographic cameras, Smartphones, tablets or similar. Furthermore, even though in this description a centering device shall be referred to as a device to measure the corresponding distances for the location of the lens, this is not a limitation for the invention, since other related devices can also be used with this invention.

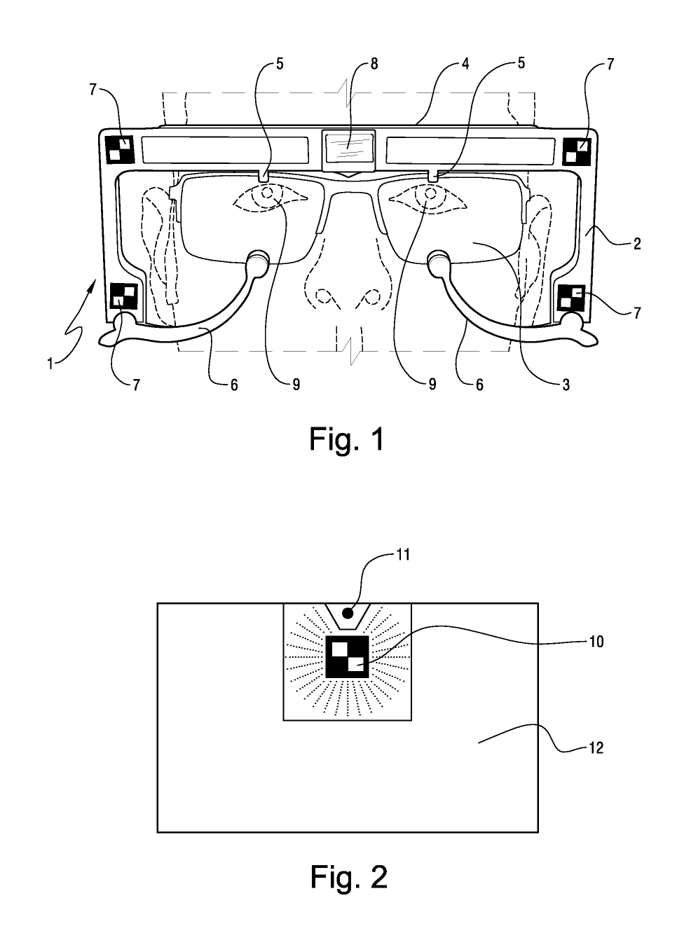

Then, and in accordance with FIGS. 1 to 4, the alignment arrangement of this invention, is usable in, for example, —but not limited to—a centering device 1 that has a frame 2 that is mounted on the frame of a pair of eyeglasses 3 of a patient 4, as is better shown in FIG. 1. This centering device 1 is mounted on the eyeglasses 3 through each upper arm 5, and through each lower arm 6, in such a way that it can be fastened firmly on the eyeglasses 3, and can be supplied with a plurality of corner marks 7 to improve the alignment and, at the same time, facilitate the subsequent measurements.

According to one of the objectives of this invention, the alignment arrangement comprises at least one reflection element 8 that can be a mirror or any type of object or material that allows a reflection. This reflection element or mirror 8 is placed in a central and upper section of the centering device 1, more particularly, it is placed between and on top of the eyes 9 of the patient 4. In order to facilitate the subsequent alignment tasks, the reflection element or mirror 8 can be pivoted to vary its up-down position or lateral position, and this is not limiting since it can also be kept in a fixed position.

On the other hand, the invention arrangement is also provided with an alignment indication mark 10 placed close to a lens 11 provided in a photographic device 12. The alignment indication mark 10 can be any type of image that can be reflected in the reflection element 8 and that facilitates the visualization to the professional for the further alignment. Image 10 can present a size similar to the size of the mirror 8 to facilitate the alignment of the photographic device 12.

This invention also provides an alignment method between the centering device 1 and the photographic device 12. For this, the centering device 1 must first be placed in the frame of the eyeglasses 3 of the patient 4, in such a way that it remains exactly as mentioned above. After this, the photographic device 12 is turned on and the lens 11 is positioned—marked 10 in approximate alignment with the reflection element 8 of the centering device 1.

Once located, the lens 11 of the photographic device is carefully re-positioned until the mark 10 placed closely is reflected in the reflection element 8, including the section of the mirror and on the same plane with the latter, so as to achieve the proper alignment. Then, the conventional way is followed taking at least one photograph to finally make the corresponding measurements.

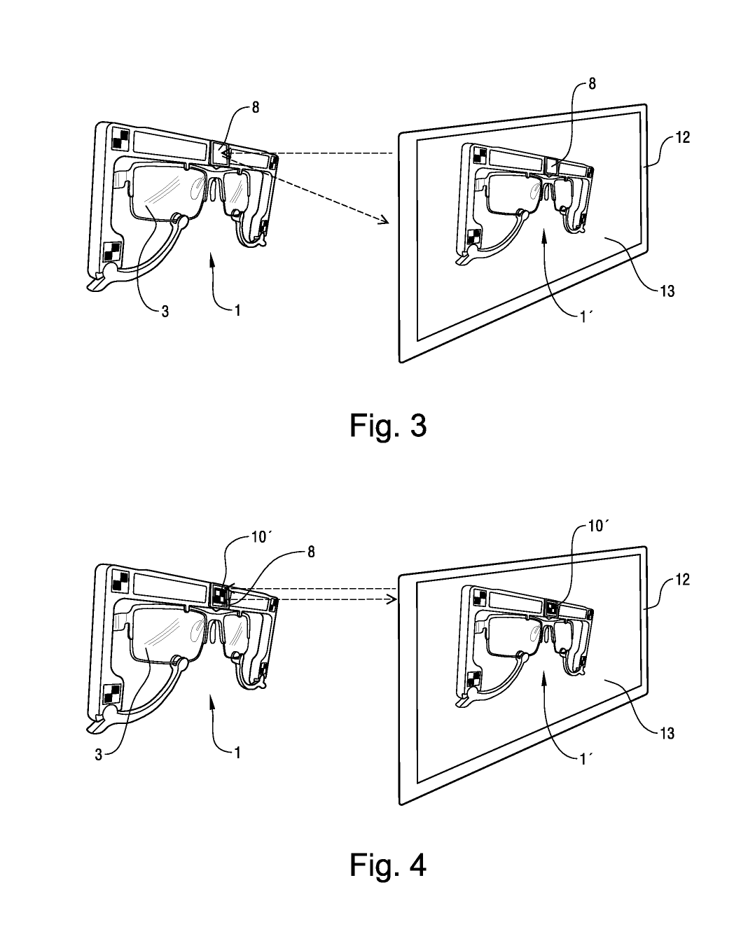

In the case where the device is not correctly aligned, FIG. 3, the mirror 8 shall not reflect any image and, in consequence, on the screen 13 of the photographic device 10, only the image of the centering device shall be seen 1′. Another possibility is that the image 10 is visualized, but does not coincide with the plane of the surface of the mirror, and thus is seen as deformed or wrongly positioned. In this case, it is also misaligned.

On the contrary, when the device is properly aligned, FIG. 4, a reflected image 10′ can be visualized in the mirror 8. The reflected image 10′ of the image 10, must remain on the same plane with the surface of the mirror 8 to achieve the correct alignment between the photographic device and the centering device. Thus, the image of the centering device 1′, can be seen on the screen 13, and the reflected image 10′ on the same plane as the mirror 8. Another way to determine the correct alignment can be done through a software which automatically detects when the three targets, two physical ones on the extremes and one reflected in the center, appear on screen.

In this way, the alignment arrangement of this invention is constituted and constructed, which notably facilitates the alignment operations between the centering device and the photographic devices. We highlight that this invention is not limited solely to centering devices, but that other similar devices to carry out measurements, if available, can be considered as well and used with the arrangement of the invention.

1. An apparatus for centering of ophthalmic lenses, comprising:
at least one reflection element placed on a portion of a centering device; and
at least one alignment indication mark arranged close to a lens of a photographic device.

2. The apparatus according to claim 1, wherein the at least one reflection element is a mirror.

3. The apparatus according to the claim 2, wherein the mirror is located in a central and upper section of the centering device, in between and over a patient's eyes.

4. The apparatus according to claim 2, wherein the mirror is fixed.

5. The apparatus according to claim 2, wherein the mirror is pivotable.

6. The apparatus according to claim 1, wherein the alignment indication mark is an image.

7. The apparatus according to claim 2, wherein the alignment indication mark is an image, wherein the image is a size similar to a size of the mirror.

8. A centering and alignment method, comprising
providing at least one reflection element placed on a portion of a centering device and at least one alignment indication mark arranged close to a lens of a photographic device:
a) placing the centering device in a frame of eyeglasses of a patient;
b) turning the photographic device on;
c) positioning the lens of the photographic device in alignment with the reflection element of the centering device;
d) re-positioning the lens in the photographic device so the mark is reflected in the reflection element and the mark reflection remains on a same plane as the reflection element;
e) taking at least one photograph; and
f) making corresponding measurements.
